(19) United States
(12) Patent Application Publication
(10) Pub. No.: US 2012/0196544 A1
(43) Pub. Date: Aug. 2, 2012

(54) SYSTEM AND METHOD FOR CONTROLLING WIRELESS DEVICE USE IN A VEHICLE

(76) Inventor: Fred Bolingbroke, Syracuse, UT (US)

(21) Appl. No.: 13/019,117

(22) Filed: Feb. 1, 2011

(51) Int. Cl. H04B 7/00

(52) U.S. Cl. 455/68

(57) ABSTRACT

Systems and methods for controlling use of a wireless device within a vehicle include emitting a mimic signal from a control unit so that the wireless device registers with the control unit rather than an external network are described. The control unit selectively allows wireless communications sessions between the wireless device and an external network based upon at least one predefined rule. Other embodiments are also described.

### FIELD

The present application relates to wireless communications systems. More particularly, the present application relates to controlling wireless device usage in a vehicle.

### BACKGROUND

Wireless communications has become ubiquitous, with increasing numbers of individuals having and using wireless devices. Unfortunately, individuals do not always use these devices in a responsible manner. A particularly problematic area is the usage of devices by drivers of moving vehicles. It is widely believed that the use of a cellular telephone while driving is a distraction to the driver that increases the likelihood of the driver being involved in an accident. Some states have gone so far as to pass laws prohibiting the use of cellular telephones while driving. Regardless of the risks and prohibitions, many individuals continue to use their cellular telephones while driving.

### SUMMARY

This application describes a method and a system of controlling the use of a wireless device within a vehicle. The system contains a control device for managing use of a wireless device within a vehicle. The control device contains a transmitter that is configured to emit a mimic signal having characteristics sufficiently similar to a wireless base station to cause the wireless device to register with the control device. The control device also contains a receiver that is configured to receive data from the wireless device. The control device also contains a vehicle interface configured to receive information from the vehicle so that it can determine an operational mode of the vehicle. A control unit can be coupled to the receiver, the transmitter, and the vehicle interface and can be responsive to the receiver to receive attempts to establish a wireless communications session by the wireless device. The transmitter can be responsive to the control unit to perform actions to selectively enable establishment of a wireless communications session between the wireless device and an external network according to any predefined rule. With such a system, a mimic signal can be emitted from the control unit that is coupled to the vehicle. The mimic signal can have characteristics sufficiently similar to a wireless base station to cause the wireless device to register with the control unit. The control unit can receive attempts to initiate wireless communication session from the wireless device, and can selectively allow a wireless communications session between the wireless device and an external network based on the predefined rule.

### BRIEF DESCRIPTION OF THE DRAWINGS

The following description can be better understood in light of the Figures, in which:

FIG. 1 is a block diagram in some embodiments of a system providing control of a wireless device;

FIG. 2 is a protocol diagram illustrating some embodiments of a message exchange between a wireless device and a control unit showing wireless device registration with the control unit;

FIG. 3 is a protocol diagram illustrating some embodiments of a message exchange between a wireless device and a control unit showing the control unit disallowing calls;

FIG. 4 is a protocol diagram illustrating other embodiments of a message exchange between a wireless device and a control unit showing the control unit disallowing calls;

FIG. 5 is a protocol diagram illustrating yet other embodiments of a message exchange between a wireless device and a control unit showing the control unit disallowing calls;

FIG. 6 is a protocol diagram illustrating some embodiments of a message exchange between a wireless device and a control unit showing the control unit allowing calls;

FIG. 7 is a protocol diagram illustrating other embodiments of a message exchange between a wireless device and a control unit showing the control unit allowing calls;

FIG. 8 is a protocol diagram illustrating yet other embodiments of a message exchange between a wireless device and a control unit showing the control unit allowing calls;

FIG. 9 is a block diagram showing some embodiments of a control unit;

FIG. 10 is a block diagram showing some embodiments of a computer system which can be used in the controller of FIG. 9;

FIG. 11 is a flow chart showing some embodiments of a process for controlling wireless device usage within a vehicle; and

FIG. 12 is a flow chart showing some embodiments of a process for determining when to allow and to disallow calls.

The Figures illustrate specific aspects of methods and systems of controlling the use of a wireless device within a vehicle. Together with the following description, the Figures demonstrate and explain the principles of the structure and methods of this circuitry. The same reference numerals in different drawings represent the same element, and thus their descriptions will not be repeated.

### DETAILED DESCRIPTION

The following description supplies specific details in order to provide a thorough understanding. Nevertheless, the skilled artisan would understand the circuit operation and methods for making and using such circuits can be implemented and used without employing all of the described details. Indeed, the devices and associated methods can be placed into practice by modifying the illustrated devices and associated methods and can be used in conjunction with any other apparatus and techniques conventionally used in the industry.

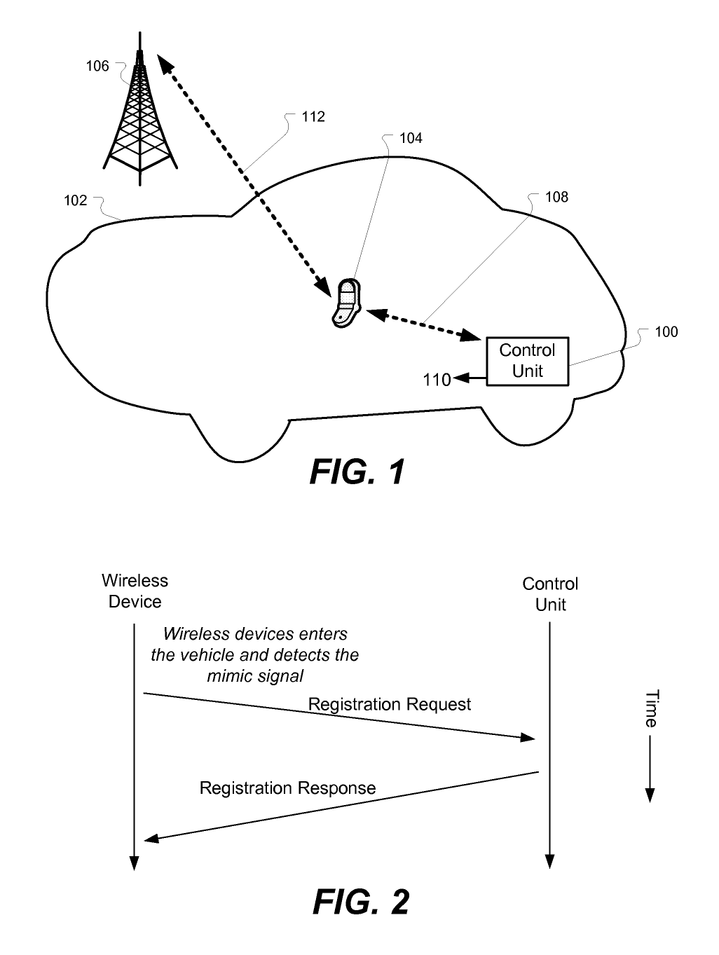

The Figures show some embodiments of a method and a system of controlling the use of a wireless device within a vehicle. FIG. 1 provides an illustration of a system for controlling wireless device usage in a vehicle. A vehicle 102 can travel within a geographic area which has a wireless network 106 (which is one example of an external communications network). The wireless network can be any known wireless network including, for example, a cellular network, a personal communications services network, a WiFi network, a wireless internet network, or the like. The vehicle can be any known vehicle, including automobiles, trucks, motorcycles, bicycles, boats, aircraft, or the like.

As depicted in FIG. 1, a control unit 100 can be installed within the vehicle 102. The control unit 100 can control the usage of a wireless device 104 within the vehicle. The wireless device can be any known wireless communication device, including a cellular telephone, personal data assistant, tablet computer, laptop computer, game system or the like.

As shown in FIG. 1, the control unit 100 can emit a mimic signal. In some embodiments, the mimic signal can be substantially contained within the vehicle. For example, as described in further detail herein, the transmission power of the control unit can be selected to help ensure that the signal strength of the mimic signal is below a predetermined level outside of the vehicle.

The mimic signal emitted from the control unit 100 can be sufficiently similar to a wireless base station to cause a wireless device 104 that is within the vehicle 102 to register with the control unit rather than with the external wireless network 106. For example, as described in further detail herein, the mimic signal can have a similar signal and data format as a base station pilot or beacon signal that is emitted from the external wireless network. The mimic signal can, in other embodiments, have a stronger signal strength within the vehicle as compared to the signal strength of the external wireless network. Accordingly, the wireless device 104 can prefer to establish a communications link 108 with the control unit rather than the external network 106. Thus, when the wireless device attempts to initiate a wireless communications session, it will communicate with the control unit rather than the external network. Thus, the control unit 100 can receive attempts to initiate wireless communications from the wireless device.

FIG. 2 illustrates a protocol diagram showing one example of message exchanges between a wireless device 104 and the control unit 100 which can occur when the wireless device is first brought into the vehicle. With time shown in the vertical axis, the wireless device and control unit are each represented by vertical lines, and message flow between the wireless device and the control unit are shown as diagonal lines (the lines are sloped to suggest the time delays associated with wireless signal propagation and message processing). Annotations shown in italics between the messages describe other activities which may occur within the wireless device or control unit (e.g., actions triggered by reception of a message, or actions which trigger the transmission of a message). When the wireless device enters the vehicle, it will detect the mimic signal. Because the mimic signal is stronger (within the vehicle) than the external network, the wireless device will attempt to register with the control unit. Thus, the wireless device will send a registration request message to the control unit. The control unit can respond with a registration response message. At this point, the wireless device is now associated with the control unit rather than the external network. Thus, the control unit (rather than the external network) will receive call requests from the wireless device, and the control unit can determine whether or not to allow the calls to go through to the external network 106, as described in further detail herein.

As shown in FIG. 1, the control unit 100 can have an interface 110 to the vehicle 102 to allow the control unit to obtain information from the vehicle. The information can be used to determine the operational mode of the vehicle. For example, the information can include whether the vehicle's engine is running, what gear the vehicle is in, whether the vehicle is moving, a speed at which the vehicle is moving, or combinations thereof. This information can be used by the control unit to determine whether the vehicle is in motion, and when to allow the wireless device 104 to initiate or receive wireless communications sessions. Alternatively or additionally, the control unit 100 can use a Global Positioning System (GPS) receiver to determine when the vehicle is in motion. For example, the GPS receiver can be interfaced to the control unit to provide movement data to the control unit.

The control unit 100 can selectively allow the wireless device 104 to engage in communication sessions with the external network 106. The communication sessions can include any known communication using the wireless device 104 including a voice call, a data session, a text message, an email message, internet communications, voice over IP call, or the like, or combinations thereof. The control unit can enable or disable calls based one or more predefined rules, including whether the vehicle is in motion or not, what telephone number is being called, or combinations thereof. In some embodiments, any desired communication can be prevented whenever the vehicle is moving (e.g., vehicle speed above a threshold of zero or other amount), whenever the vehicle is in a gear capable of allowing movement (e.g., reverse, drive, 1^{st} gear, etc.), or when the vehicle engine is on. In other embodiments, any desired communication can be allowed when the vehicle is stopped, when the vehicle is in a non-moving gear (e.g., park), or when the vehicle engine is off. For example, voice calls can be prevented when the vehicle is moving by turning the mimic signal on, and calls can be allowed when the vehicle is stopped by turning the mimic signal off.

In some configurations, communications can be enabled when a Bluetooth wireless link or any similar hands-free system is being used. Various ways can be used to determine when the wireless device is using a hands-free system. For example, the control unit 100 can include a receiver that can be used to detect when Bluetooth signals are being exchanged between a hands-free device and the wireless device. As another example, the vehicle can include a docking station or link to the wireless device that permits hands-free operation, and the docking status information can be related to the control unit 100.

In some embodiments, any desired communication can be allowed based on the destination of the call regardless of other rules (i.e., the vehicle movement or engine status). For example, voice calls to emergency telephone numbers (e.g., 911) can be allowed at any time. As another example, voice calls to a list of different pre-defined telephone numbers can be allowed at any time. As another example, data sessions to pre-defined destinations (e.g., Internet Protocol address, email address, etc.) can be allowed at any time. The pre-defined list of numbers can be specified by government authorities, a vehicle owner (e.g., the owner of a corporate fleet), or any other person or entity.

Various ways of implementing and operating the control unit 100 are possible. In some embodiments, the control unit can operate as follows. When the wireless device 104 attempts to initiate a call, it will typically send a call set up request to the base station to which it is registered. Hence, when the wireless device is inside the vehicle, it will have registered with the control unit. The wireless device will then send the call set up request to the control unit. Normally, the wireless device expects a call set up assignment to be sent back from the base station, at which point the wireless device proceeds with the call, typically using an assigned frequency or code channel specified by the base station.

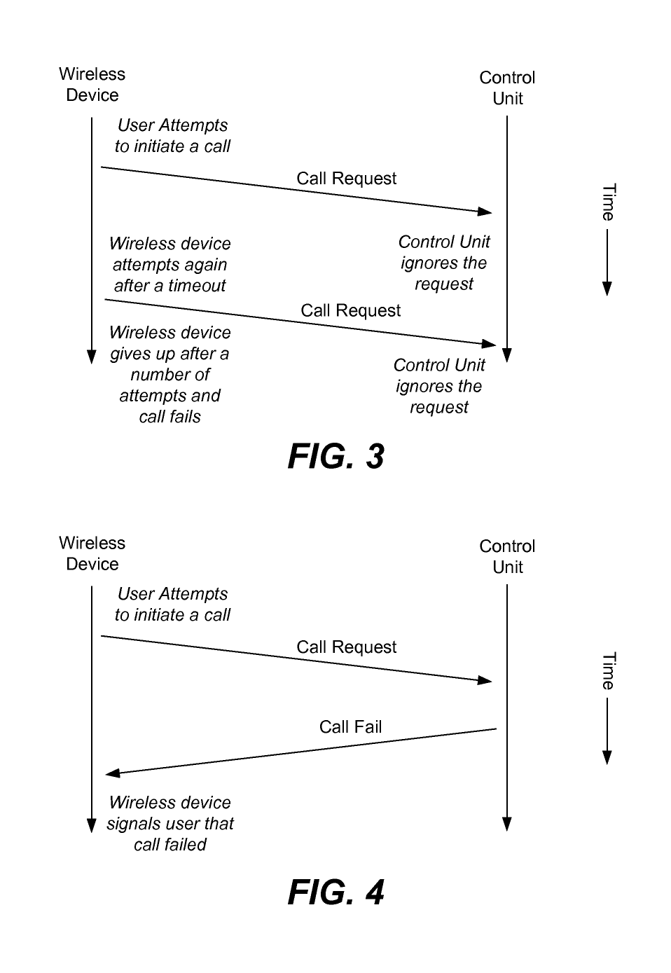

In some embodiments, the control unit 100 can prevent calls by simply ignoring the call set up request. Since the wireless device 104 never receives a call set up assignment, it never proceeds with the call. The wireless device may send additional call set up requests when response is not received, but these requests can also be ignored by the control unit, thus preventing the call from being initiated. Some wireless devices will, after a timeout interval, provide an indication to the wireless device user that the call could not be completed. For example, FIG. 3 illustrates a protocol diagram showing that the wireless device can send one or more call setup messages which are all ignored by the control unit, ultimately causing the call to fail.

In other embodiments, as shown in FIG. 4, the control unit 100 can prevent calls by responding to the call set up request with a message that indicates it is not possible to set up or otherwise initiate the call at a designated time. This configuration can avoid the wireless device 104 sending multiple call set up requests. This configuration can also allow for reduced battery power consumption of the wireless device. Typically, the wireless device will provide an indication to the wireless device user that the call could not be completed.

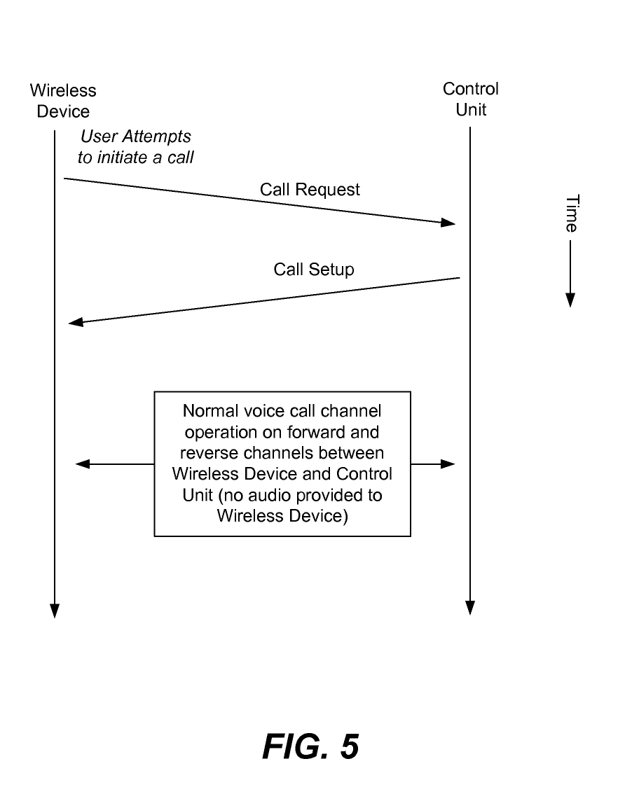

In yet other embodiments, as shown in FIG. 5, the control unit 100 can prevent calls by sending a call set up assignment to the wireless device 104 that makes it appear to the wireless device that the call is going through. The control unit can then provide sufficient communications with the wireless device to keep the wireless device operating as though it is engaged in a call. The control unit need not actually complete the call, and can ensure that data sent to the wireless device results in silence. This configuration can avoid a call failure indication to the wireless device user, and thus may be less distracting than the examples shown in FIGS. 3-4. Alternatively, the control unit can encode and transmit audio messages through the wireless communications session to the wireless device. For example, the control unit can provide an advisory that calls are not permitted while the vehicle is in motion.

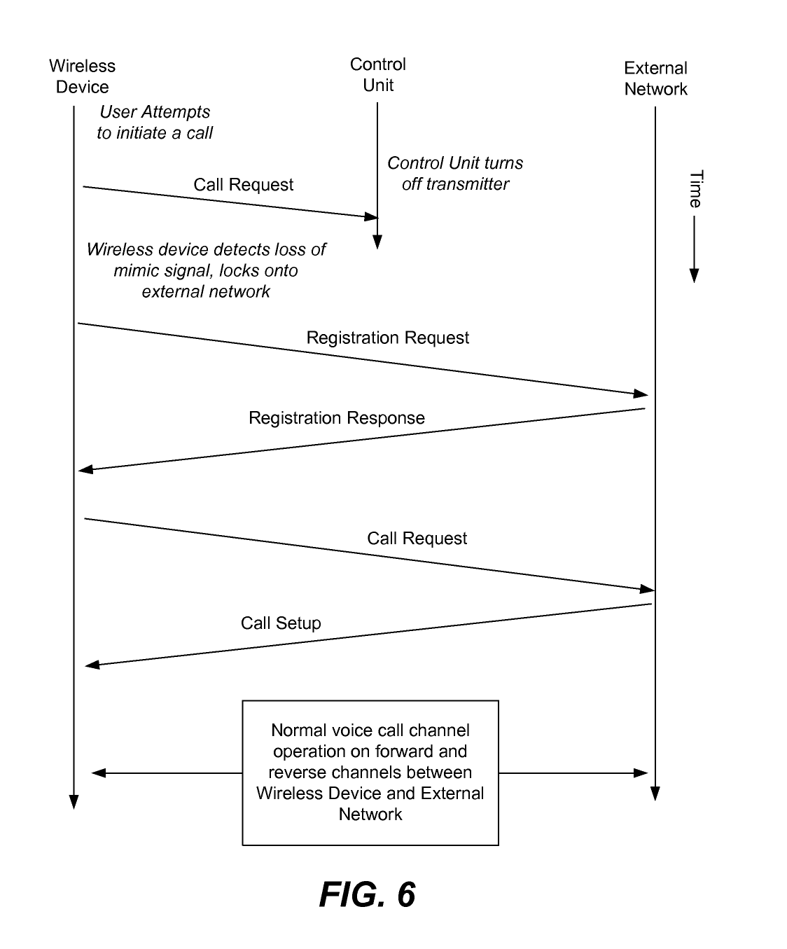

The control unit 100 can allow calls using any number of different techniques. In some embodiments, the control unit can simply stop emitting the mimic signal. In these embodiments, the wireless device 104 will realize it has been disconnected and will attempt to reconnect. Since the mimic signal is no longer present, the wireless device will instead establish a communications link 112 with the external network 106. The wireless device can then proceed to operate normally, as illustrated in FIG. 6. In some instances, however, this approach may cause the initial attempt to place the call to fail, requiring the wireless device user to redial.

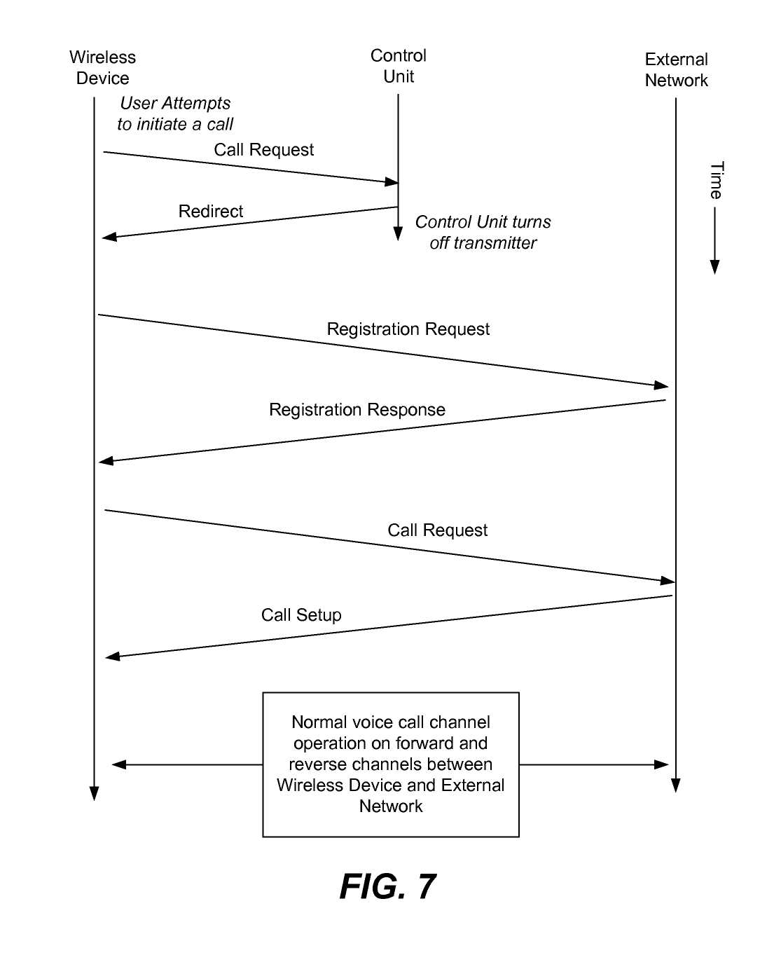

In other embodiments, the control unit 100 can allow calls by sending a redirect message to the wireless device that causes it to switch to the external network. The control unit can then shut off or reduce the power of its transmission to help avoid the wireless device locking back onto the control unit, as illustrated in FIG. 7. In some instances, this approach may also cause the initial attempt to place the call to fail, requiring the wireless device user to redial.

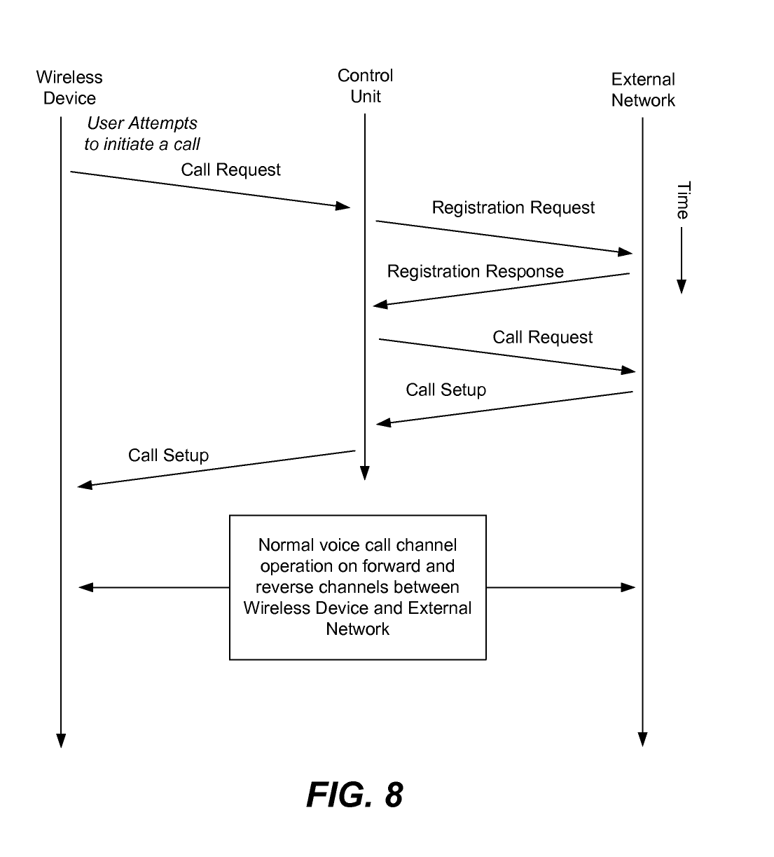

In yet other embodiments, the control unit 100 can allow calls by exchanging messages with the external network to register the wireless device with the external network and then sending a message to the wireless device to cause it to establish communications with the external network, as illustrated in FIG. 8. In other words, the control unit can appear to be a base station from the perspective of the wireless device, and the control unit can appear to be a wireless device from the perspective of the base station. Thus, the control unit exchanges registration messages and call setup messages with the external network as if it was the wireless device, and the control unit exchanges call set up messages with the wireless device as if it was a base station for the external network. One the messages have been exchanged, the wireless device will tune to the channels/codes assigned in the call setup message and communicate directly with the external network without the wireless device being aware that it was transferred. In the event that the communications between the control unit and the external network takes sufficient time, the wireless device may transmit a second call request message (not shown) which can be disregarded by the control unit (since it is already in the process of setting up the call).

In yet other embodiments, the control unit 100 can allow calls by initially setting of call channels similarly to FIG. 5, and then immediately causing the wireless device to handoff to the external network.

Of course, the foregoing embodiments are only examples of preventing and allowing communications. Different messages and sequences of messages can be exchanged, and the specifics can be dependent on the particular protocols supported by the external communications network.

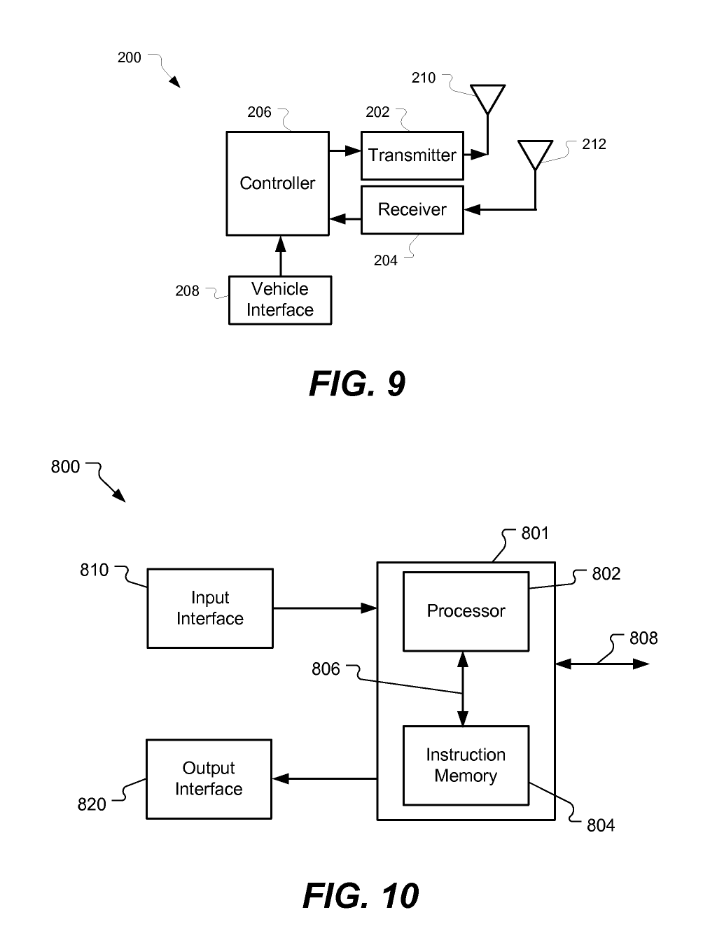

Various ways of implementing the control unit 100 into the system illustrated in FIG. 1 are possible. For example, FIG. 9 provides a block diagram of some embodiments of a control unit 200 that can be used in place of—or in addition to—the control unit 100 in FIG. 1. The control unit 200 can include a transmitter 202, a receiver 204, a controller 206, a vehicle interface 208, and one or more antennas 210, 212. The transmitter 202 can be used to transmit a mimic signal, as described above. The transmitter can, for example, include any known type of transmitter, such as a base station transmitter. Accordingly, the transmitter can transmit a paging channel.

The paging channel can be compliant with any known communication specification and/or standard. In some embodiments, the paging channel can comply with the CDMA2000 system specifications (also referred to as “3G cellular” or “CDMA cellular”). There exist any number of variants of the CDMA2000 standard in operation around the world, and the transmitter 202 can be compliant with one or more of the existing standards. As a particular example, the system can be compliant with CDMA2000 1x, CDMA2000 1xEV-DO (e.g., Rel. 0, Rev. A, or Rev. B) and CDMA 2000 1xEV-DV. In some cases, compliance with one standard also provides backwards compatibility with earlier standards. As another example, the paging channel can be compliant with an emerging cellular standard that is still under development, such as CDMA2000 3x and the 3rd Generation Partnership Project 2 (3GPP2) Long Term Evolution (LTE) or 4G cellular wireless network standards.

In other embodiments, the transmitted paging channel can be compliant with the UMTS system specifications (also referred to as “3G cellular” or “WCDMA”). Like CDMA2000, there are a number of variants of the UMTS system and the transmitter 202 can be compliant with one or more of the existing standards, such as for example UMTS Release 99, any of UMTS Release 4-9, or standards still under development such as the 3^{rd} Generation partnership Project (3GPP) LTE.

The transmitter 202 can transmit additional logical and physical channels (known as “forward channels”) in addition to the paging channel. For example, to produce a CDMA2000 mimic signal, a pilot channel can also be transmitted. As another example, to produce a UMTS mimic signal, the paging channel and a broadcast control channel can be transmitted within a primary common control physical channel.

The transmitter 202 can be configured to transmit the mimic signal using similar signal formats and frequency allocations as used by the cellular network (or networks) in the geographic area in which the vehicle is expected to operate. For example, if the vehicle is expected to operate within the U.S., the mimic signal can use signal formats and frequency allocations corresponding to U.S. cellular systems.

In some situations (e.g., the U.S.), there may be multiple cellular networks operating using different frequency allocations and/or signal formats. In such a situation, the control unit 202 can include multiple transmitters 202. The transmitters can transmit a plurality of signals corresponding to multiple cellular system types. For example, one transmitter can transmit CDMA2000 signals and another transmitter can transmit UMTS signals. As another example, multiple transmitters can be used to transmit signals in multiple frequency bands (e.g., within the 800 MHz cellular band, within the 1800-1900 MHz personal communications bands, or within other bands).

The transmitter 202 can be coupled to the antenna 210 to allow for radiation of the mimic signal emitted by the transmitter. As mentioned above, the signal strength of the mimic signal emitted by the transmitter 202 can be set to a level where it is higher than the signal strength of external networks within the vehicle, but can be substantially contained within the vehicle. For example, a mimic signal that is at a sufficiently low level outside the vehicle so that wireless devices outside the vehicle do not attempt to register with the control unit is substantially contained within the vehicle. As another example, a mimic signal is substantially contained within the vehicle if the mimic signal is at a sufficiently low level outside of the vehicle so that degradation to wireless communications of wireless devices outside the vehicle is less than a predetermined amount. The predetermined amount can be, for example, 3 dB, 1 dB, 0.5 dB, or any other suitable value.

The signal strength of the mimic signal can be determined by both the power output of the transmitter and the antenna gain. As antennas are directional, the gain pattern of the antenna can be tailored to help contain the mimic signal within the vehicle. For example, for an antenna mounted near an exterior surface of the vehicle, the antenna gain pattern can be oriented to radiate most of the power toward the interior of the vehicle while minimizing power radiated toward the exterior of the vehicle. If desired, multiple antennas can be used. For example, an antenna near the forward portion of the passenger compartment can provide mimic signal coverage of the driver and front passenger seats, and an antenna near the rear portion of the passenger compartment can provide mimic signal coverage of the rear passenger seats. If desired, the coverage of the mimic signal can be limited to be less than the entire interior of the vehicle. For example, the mimic signal can be substantially contained within a limited area that covers the area of the driver, thereby allowing wireless device usage by passengers.

The receiver 204 can receive data from wireless devices within the vehicle or within a limited area within the vehicle. The receiver can be configured to receive a random access channel (e.g., the CDMA2000 RACH or the UMTS RACH). The receiver can also receive other channels (known as “reverse channels”). In some embodiments, the receiver can include a base station receiver. The receiver can be coupled to the antenna 212. Alternatively, the transmitter 210 and receiver 212 can share a same antenna (not shown), for example, using a diplexer. If desired, multiple receivers can be included. For example, multiple receivers corresponding to different cellular system standards can be included. As another example, a receiver compatible with the Bluetooth standard can be included to allow detection of when a Bluetooth link is active.

The controller 206 can interface with the transmitter 202 and receiver 204, as shown in FIG. 9. The controller 206 can provide signal parameters (e.g., transmit on/off, transmit power level, transmit modulation, transmit signal format, etc.) and data for transmission (e.g., layer 2 messages) to the transmitter. The controller can also provide signal parameters (e.g., receive on/off, receive modulation, receive signal format, etc.) to the receiver. The controller can also accept data received (e.g., layer 2 messages) from the receiver.

The controller 206 can implement logic to implement various signaling protocols between the control unit 200 and a wireless device. The vehicle interface 208 can provide the controller 206 with information sufficient to determine the operational mode of the vehicle in which the control unit is installed. In some embodiments, the vehicle interface can be an electronic interface to the vehicle engine controller. The vehicle interface can provide information such as vehicle speed, vehicle gear, vehicle engine status (on/off, etc.), or combinations thereof. The controller 206 can use the operational mode of the vehicle to determine whether to allow communications sessions between the wireless device and the external network. For example, the control unit can selectively enable wireless communications sessions according to one or more predefined rules. The control unit can be responsive to messages received from the receiver attempting to establish a call by sending signal parameters and/or data to the transmitter to selectively enable calls, for example as described above.

In some embodiments, the controller 206 can include a computer system, in which some or all of the processing logic can be implemented. For example, FIG. 10 illustrates an embodiment of a computer system 800 which can be used to implement one or more of the blocks of the controller shown in FIG. 9. The computer system can include a general-purpose or special-purpose processing subsystem 801. For example, the computer system can be a personal computer, a notebook computer, a workstation, a minicomputer, a mainframe, a supercomputer, a multi-processor system, a processor-based electronic device, or the like, which is coupled to the other components of the control unit 200. The processing subsystem can include a processor 802 and an instruction memory 804. The processor can be capable of executing computer-executable instructions received from the instruction memory via a bus 806 or similar interface. The processor can be a single processor or multiple processors (e.g., a central processor and one or more other processors designed to perform a particular function or task). The instruction memory can be integrated into the same semiconductor device or package as the processor. The bus can be configured to connect various components of the computer system, and can include any of a variety of bus structures including a memory bus or memory controller, a peripheral bus, or a local bus that uses any of a variety of bus architectures. The bus can be used to interconnect the processor, instruction memory, and other components, such as mass storage devices, input/output interfaces, network interfaces, and the like.

As describer further below, computer-executable instructions can cause the processor 802 to execute functions to implement logical operations, for example as described above, and as described in further detail below. The computer-executable instructions can be permanently stored in the instruction memory 804 or temporarily stored in the instruction memory and loaded into the instruction memory from a computer-readable medium, for example, via an interface 808. The computer-executable instructions can include data structures, objects, programs, routines, or other program modules that can be accessed by the processor. For example, computer executable instructions can include operating system instructions used to establish communication or enable loading of programs, such as during start-up of the computer system. In general, computer-executable instructions can cause the processor to perform a particular function or group of functions and are examples of program code means for implementing methods disclosed herein. Furthermore, a particular sequence of the executable instructions provides an example of corresponding acts that can be used to implement the operations of such methods.

Examples of computer-readable media include random-access memory (RAM), read-only memory (ROM), programmable read-only memory (PROM), erasable programmable read-only memory (EPROM), electrically-erasable programmable read-only memory (EEPROM), compact disk read-only memory (CD-ROM), digital video disk (DVD), magnetic medium, or other suitable device or component that is capable of providing data or executable instructions that can be accessed by the processor 802. Computer-readable media can be a non-transitory media (e.g., a physical device as described above) which allows for permanent, semi-permanent, or temporary storage of executable instructions.

The computer system 800 can include various input/output interfaces, including for example an input interface 810 and an output interface 802. The input interface can use, for example, a serial interface, a parallel interface, a universal serial bus (USB) interface, a Firewire interface (IEEE 1394), and the like. The output interface can be the same or different than the input interface. The input interface can be used to accept receive data from the receiver, to receive vehicle information from the vehicle interface, and to interface to other components of the control unit. The output interface can be used to provide transmit data to the transmitter, to provide configuration and control information to the transmitter and receiver, and to interface to other components of the control unit.

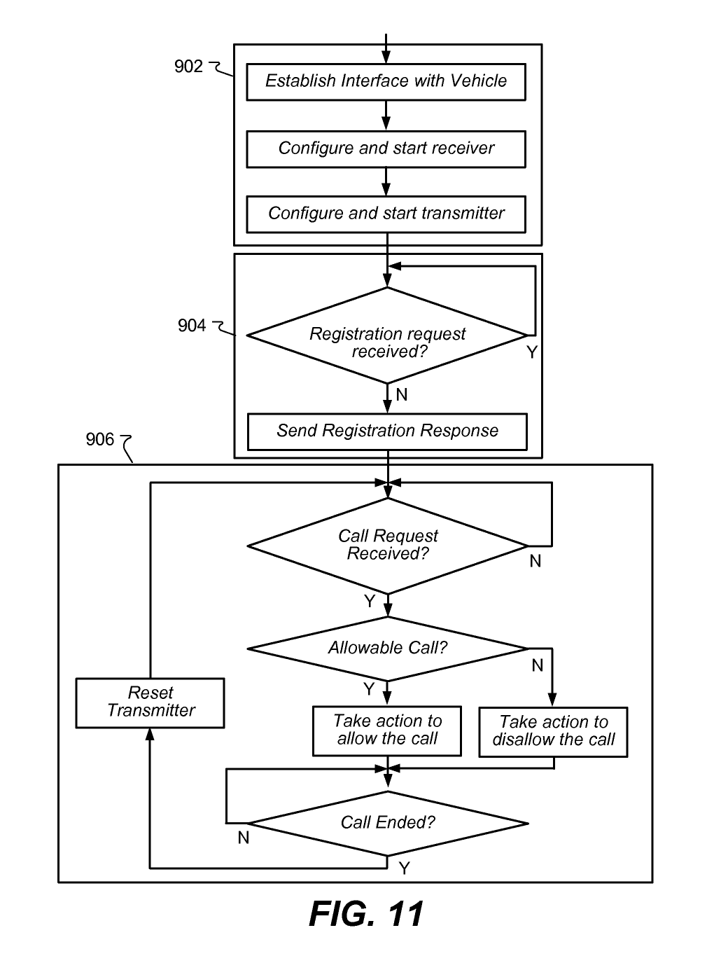

The computer system 800 can be used to implement a process for controlling wireless device usage within a vehicle in distinct software modules. The software modules can cause the processor 802 to implement these modules. For example, the instructions can correspond to the flow chart of FIG. 11. In some embodiments, the software modules can include an initialization module 902, a registration module 904, and a call management module 906.

The initialization module 902 can cause the computer system 800 to establish an interface with the vehicle. For example, the interface can provide vehicle state information to the computer system. The vehicle state information can be provided on a regular basis (e.g., a predefined interval) or an irregular basis (e.g., whenever state changes). The initialization module can also cause the computer system to configure and turn on the transmitter and to configure and turn on the receiver.

The registration module 904 can cause the computer system 800 to check for registration messages received from the wireless device. When a registration message is received, the registration module can cause the computer system to initiate transmission of a registration response message.

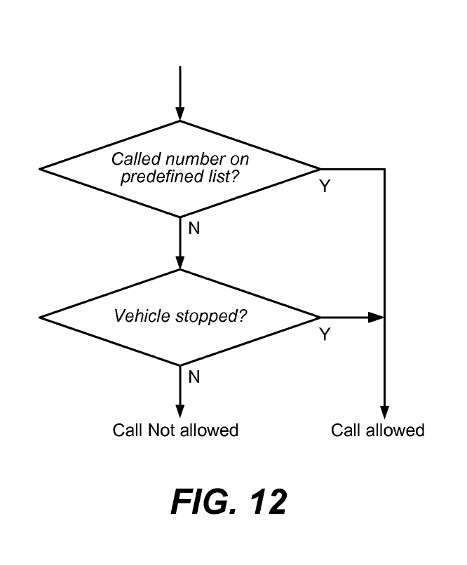

The call management module 906 can cause the computer system 800 to selectively enable and disable calls. When a call request is received, the call management module can check whether the call is allowed. The call management module can use predefined rules, vehicle state information, and the destination of the wireless communications session (e.g., phone number being called) in determining whether the call is allowed, for example as described above. FIG. 12 illustrates a flow chart of one example of an implementation of logical functions to determine when a call is allowed. When the call will be allowed, the call management module can enable the call (e.g., transmit specific messages to the wireless device, transmit specific messages to the external network, disable the transmitter, or other actions as described herein). When the call is to be disallowed, the call management module can prevent the call (e.g., take no action, transmit specific messages to the wireless device, or other actions as described herein). When the call is complete, the call management module can perform any necessary actions to prepare for receiving subsequent registration or call request messages (e.g., turning back on the transmitter). Detecting when the call is complete can, for example, include monitoring the forward and/or reverse channels being used by the call using the receiver(s).

While the devices and methods described above have used specific examples of particular messages and sequencing of messages between the control unit, wireless device, and external network, many other sequences and particular messages can be used to provide similar effects. Data messaging can be managed in a similar manner (e.g., disallowing transmission or reception of text messages when the vehicle is in motion). Devices other than cellular telephones (e.g., personal data assistants, tablet computers, etc.) may provide capability to make telephone calls (e.g., through data networks such as “Wi-Fi” hot spots). Hence, it may prove beneficial to manage such types of communications as well. Accordingly, in some embodiments the control unit can emulate a non-cellular data network (e.g., a data network, a WiMax network, and the like).

The techniques described herein can provide a number of useful features. First, by selectively blocking some types of telephone calls, distractions to a driver can be reduced which may, in turn, reduce the risk of accidents. Thus, insurance companies can offer discounts to drivers who the systems described herein installed within their vehicles and employers may choose to install such systems to reduce their liability risk. A second feature is that since calls can be selectively enabled, risk of disruption of important emergency communications can be reduced or eliminated. This feature can help allow Federal Communications Commission approval for deployment of the system.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A method of controlling use of a wireless device within a vehicle, comprising:
emitting a mimic signal from a control unit coupled to the vehicle, the mimic signal having characteristics sufficiently similar to a wireless base station to cause the wireless device to register with the control unit;
receiving attempts to initiate wireless communication sessions from the wireless device by the control unit; and
selectively allowing a wireless communications session between the wireless device and an external network based on a predefined rule.

2. The method of claim 1, wherein the predefined rule comprises allowing wireless communications when the vehicle is not in motion.

3. The method of claim 1, wherein the predefined rule comprises disallowing wireless communications when the vehicle is in motion.

4. The method of claim 1, wherein the predefined rule comprises allowing wireless communications when the wireless device is calling an emergency number regardless of whether the vehicle is in motion.

5. The method of claim 1, wherein the predefined rule comprises allowing wireless communications when the wireless device is calling a number on a predefined list of allowed numbers regardless of whether the vehicle is in motion.

6. The method of claim 1, wherein the wireless communication session is a voice call.

7. The method of claim 1, wherein emitting the mimic signal comprises transmitting a paging channel from the control unit.

8. The method of claim 7, wherein the paging channel is compliant with the CDMA2000 system specifications.

9. The method of claim 7, wherein the paging channel is compliant with the UMTS system specifications.

10. The method of claim 1, wherein emitting the mimic signal comprises transmitting a plurality of signals corresponding to multiple cellular system types.

11. The method of claim 3, wherein detecting when the vehicle is in motion comprises receiving speed information from the vehicle.

12. The method of claim 3, wherein detecting when the vehicle is in motion comprises receiving transmission gear selection information from the vehicle.

13. The method of claim 3, wherein detecting when the vehicle is in motion comprises receiving information from a Global Positioning System receiver.

14. The method of claim 1, wherein selectively allowing wireless communication sessions comprises disabling transmission of the mimic signal.

15. The method of claim 1, wherein selectively allowing wireless communication sessions comprises transmitting a message to the wireless device to cause the wireless device to register with an external network.

16. The method of claim 1, wherein selectively allowing wireless communication sessions comprises:
exchanging messages with an external network to register the wireless device with the external network; and
sending a message to the wireless device to cause it to establish communication with the external network.

17. The method of claim 1, wherein the mimic signal is substantially stronger within the vehicle than signals originating from the external network.

18. The method of claim 1, wherein the mimic signal is substantially contained within the vehicle.

19. A control device for managing use of a wireless device within a vehicle, comprising:
a transmitter configured to emit a mimic signal having characteristics sufficiently similar to a wireless base station to cause the wireless device to register with the control device;
a receiver configured to receive data from the wireless device;
a vehicle interface configured to receive information from the vehicle sufficient to determine an operational mode of the vehicle; and
a control unit coupled to the receiver, the transmitter, and the vehicle interface, wherein the control unit responds to the receiver to receive attempts to establish a wireless communications session by the wireless device, and the transmitter responds to the control unit to perform actions to selectively establish a wireless communications session between the wireless device and an external network according to a predefined rule.

20. The control unit of claim 19, wherein the predefined rule includes when the vehicle is not moving, when the vehicle is not in a traveling gear, when the wireless device is attempting to call an emergency number, and when the wireless device is attempting to call one of a plurality of predefined numbers.

21. The control unit of claim 19, wherein the transmitter comprises a base station transmitter.

22. The control unit of claim 21, wherein the transmitter transmits a waveform compliant with CDMA2000 waveform or UMTS waveform standards.

23. The control unit of claim 19, wherein the receiver comprises a base station receiver.
